(19) United States
(12) Patent Application Publication
(10) Pub. No.: US 2025/0181279 A1
(43) Pub. Date: Jun. 5, 2025

(54) PRINTING CONTROL DEVICE, PRINTING CONTROL METHOD, AND PROGRAM

(71) Applicant: Seiko Instruments Inc., Chiba-shi (JP)

(72) Inventor: Tomoki OGURA, Chiba-shi (JP)

(21) Appl. No.: 18/965,050

(22) Filed: Dec. 2, 2024

(30) Foreign Application Priority Data
Dec. 4, 2023 (JP) 2023-204554

(51) Int. Cl. G06F 3/12

(52) U.S. Cl. CPC G06F 3/1203; G06F 3/1234; G06F 3/1236; G06F 3/1287; G06F 3/1289; G06F 3/1293

(57) ABSTRACT

A printing control device includes: an identification information acquisition module configured to acquire page identification information that identifies a web page of a request source among a plurality of web pages; a print request acquisition module configured to acquire a print request that is a request regarding a printing apparatus from the web page identified by the page identification information; a control instruction transmission module configured to transmit a control instruction based on the print request to the printing apparatus; a response reception module configured to receive, from the printing apparatus that transmits a response corresponding to the control instruction, the response; a determination module configured to determine whether the web page that has output the print request is ready to be notified; and a response notification module configured to notify the web page that has output the print request of information regarding the response when the determination module determines that the web page that has output the print request is ready to be notified, and otherwise avoid notifying the web page that has output the print request of the information regarding the response.

### RELATED APPLICATIONS

This application claims priority to Japanese Patent application No. JP2023-204554, filed on Dec. 4, 2023, the entire content of which is incorporated herein by reference.

### BACKGROUND OF THE INVENTION

### 1. Field of the Invention

The present invention relates to a printing control device, a printing control method, and a program.

### 2. Description of the Related Art

Hitherto, there has been a technology for performing printing from a web page on a web browser through use of a program written in a script language or the like on the web page.

In such a printing technology, printing is directly performed from a web page through connection established to a printing apparatus, or print data is passed to relay software running on a terminal on which a web browser is running through connection established to the relay software and then printing is performed from the relay software through connection established to a printing apparatus (see, for example, Japanese Patent Application Laid-open No. 2021-86329).

In regard to such a web browser or web page, in some cases, the program may be interrupted or stopped at a timing that is not intended by the program due to a web browser closing operation, a web page closing operation, or the like performed by a user using the web browser or web page. There has been a problem in that, in a case in which a web page is closed in a situation that is not intended by the program immediately after a print instruction operation was performed on the web page, when a response notification to the print instruction operation is sent from the printing apparatus, an unintended behavior may occur in the web browser, the web page, or the like.

The present invention has been made in view of the above-mentioned circumstances, and has an object to provide a printing control device, a printing control method, and a program that can inhibit an unintended behavior of a web page involved in printing.

### SUMMARY OF THE INVENTION

According to one embodiment of the present invention, there is provided a printing control device including: an identification information acquisition module configured to acquire page identification information that identifies a web page of a request source among a plurality of web pages; a print request acquisition module configured to acquire a print request that is a request regarding a printing apparatus from the web page identified by the page identification information; a control instruction transmission module configured to transmit a control instruction based on the print request to the printing apparatus; a response reception module configured to receive, from the printing apparatus that transmits a response corresponding to the control instruction, the response; a determination module configured to determine whether the web page that has output the print request is ready to be notified; and a response notification module configured to notify the web page that has output the print request of information regarding the response when the determination module determines that the web page that has output the print request is ready to be notified, and otherwise avoid notifying the web page that has output the print request of the information regarding the response.

In the above-mentioned thermal printer control device according to the one embodiment of the present invention, wherein the identification information acquisition module is configured to generate the page identification information based on information indicating a status of connection to the web page, to thereby acquire the page identification information.

In the above-mentioned thermal printer control device according to the one embodiment of the present invention, wherein the response includes information indicating an identification result of the web page based on the page identification information, and wherein the response notification module is configured to notify, based on the identification result, the web page identified by the page identification information of the information regarding the received response with the print request and the response being associated with each other.

In the above-mentioned thermal printer control device according to the one embodiment of the present invention, wherein the control instruction transmission module is configured to transmit, to the printing apparatus, a specific control instruction corresponding to the page identification information, and wherein the response reception module is configured to receive the identification result corresponding to the specific control instruction from the printing apparatus.

In the above-mentioned thermal printer control device according to the one embodiment of the present invention, wherein the specific control instruction comprises, among control instructions of the printing apparatus, a control instruction requiring a response to the control instruction from the printing apparatus and involving no operation of a printing mechanism of the printing apparatus.

According to one embodiment of the present invention, there is provided a printing control method, which is performed by a computer device, including: acquiring page identification information that identifies a web page of a request source among a plurality of web pages; acquiring a print request that is a request regarding a printing apparatus from the web page identified by the page identification information; transmitting a control instruction based on the print request to the printing apparatus; receiving, from the printing apparatus that transmits a response corresponding to the control instruction, the response; determining whether the web page that has output the print request is ready to be notified; and notifying the web page that has output the print request of information regarding the response when it is determined that the web page that has output the print request is ready to be notified, and otherwise avoiding notifying the web page that has output the print request of the information regarding the response.

According to one embodiment of the present invention, there is provided a program for causing a computer device to: acquire page identification information that identifies a web page of a request source among a plurality of web pages; acquire a print request that is a request regarding a printing apparatus from the web page identified by the page identification information; transmit a control instruction based on the print request to the printing apparatus; receive, from the printing apparatus that transmits a response corresponding to the control instruction, the response; determine whether the web page that has output the print request is ready to be notified; and notify the web page that has output the print request of information regarding the response when it is determined that the web page that has output the print request is ready to be notified, and otherwise avoid notifying the web page that has output the print request of the information regarding the response.

### BRIEF DESCRIPTION OF THE DRAWINGS

FIG. 1 is a diagram for illustrating an example of a functional configuration of a printing system in at least one embodiment of the present invention.

FIG. 2 is an example of a web page displayed on a display device in the at least one embodiment.

FIG. 3 is a table for showing an example of a correspondence relationship between a web page and page identification information in the at least one embodiment.

FIG. 4 is a flow chart for illustrating an example of a flow of operations of the printing system in the at least one embodiment.

FIG. 5A and FIG. 5B are tables for showing an example of structures of a control instruction and a response in the at least one embodiment.

FIG. 6A and FIG. 6B are tables for showing a modification example of the structures of the control instruction and the response in the at least one embodiment.

FIG. 7A and FIG. 7B are diagrams for illustrating an example of a determination operation performed by a determination module in the at least one embodiment.

### DETAILED DESCRIPTION OF THE PREFERRED EMBODIMENTS

Now, a printing system 1 in at least one embodiment of the present invention is described with reference to the drawings. In the following description, components having the same or similar function are denoted by the same reference symbols. Further, in some cases, overlapping description of the components is omitted.

### [Functional Configuration of Printing System 1]

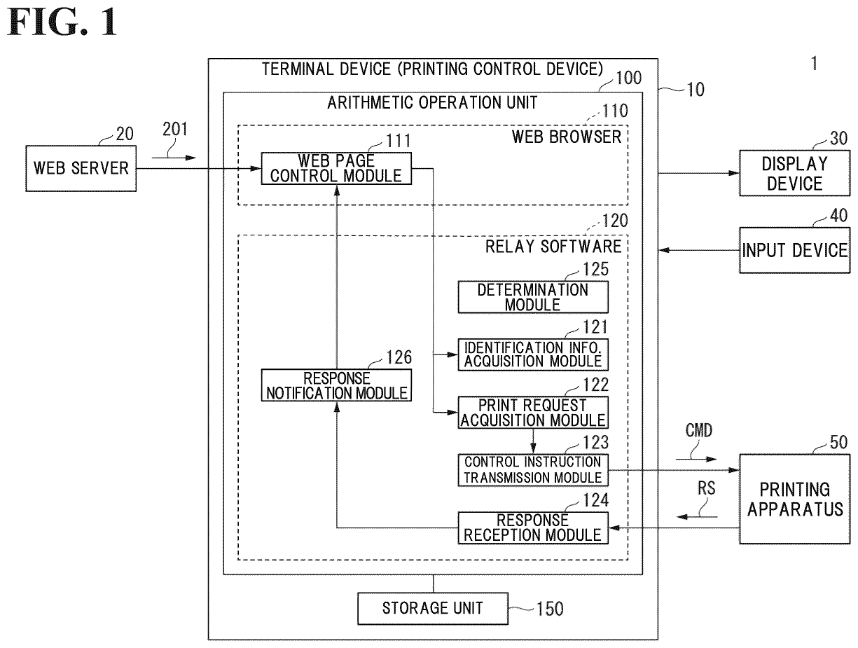

FIG. 1 is a diagram for illustrating an example of a functional configuration of a printing system 1 in the at least one embodiment. The printing system 1 in the at least one embodiment is a computer system capable of printing information (hereinafter also referred to as “web page W”) formed in a description language such as a hypertext markup language (HTML) by HTML browser software (so-called web browser) running on a computer device. The printing system 1 includes a terminal device 10, a web server 20, a display device 30, an input device 40, and a printing apparatus 50.

The web server 20 is a computer device, and provides the terminal device 10 with HTML data 201 such as the web page W. The display device 30 includes, for example, a liquid crystal display, and displays an image under the control of the terminal device 10. The input device 40 includes, for example, a keyboard, a mouse, and a touch panel, and detects an operation performed by a user on the terminal device 10 to give an instruction based on the operation of the user to the terminal device 10.

The terminal device 10 is, for example, a computer device such as a personal computer, a tablet computer, or a smartphone. The terminal device 10 includes an arithmetic operation unit 100 and a storage unit 150.

The arithmetic operation unit 100 includes, for example, a central processing unit (CPU), and operates based on programs and data stored in the storage unit 150 to provide various functions. The storage unit 150 includes, for example, a semiconductor memory or a hard disk drive, and stores programs and data for operating the arithmetic operation unit 100. The storage unit 150 may be a virtual memory (for example, a cloud memory) or the like formed on a network.

The arithmetic operation unit 100 executes a web browser 110 and relay software 120. The relay software 120 as used herein refers to software for relaying data between the web browser 110 and the printing apparatus 50. The web browser 110 includes, as software functional module thereof, a web page control module 111. The web page control module 111 executes a program written in a script language such as JavaScript (trademark), and interprets the HTML data 201 provided from the web server 20 to display characters and images of the web page W on the display device 30 or the like. In the following description, the above-mentioned program written in a script language, which is executed by the web page control module 111, is also referred to as “print script.”

The web browser 110 also has a function (hereinafter also referred to simply as “print function”) of using the print script for the web page W to generate data for printing and transmit the data for printing to the relay software 120 and causing the printing apparatus 50 to print content of the web page W. In the following description, the print script of the web browser 110 causing the printing apparatus 50 to print the content of the web page W is also referred to as “print request.” The web page W that has made a print request is also referred to as “web page W of the print request source.”

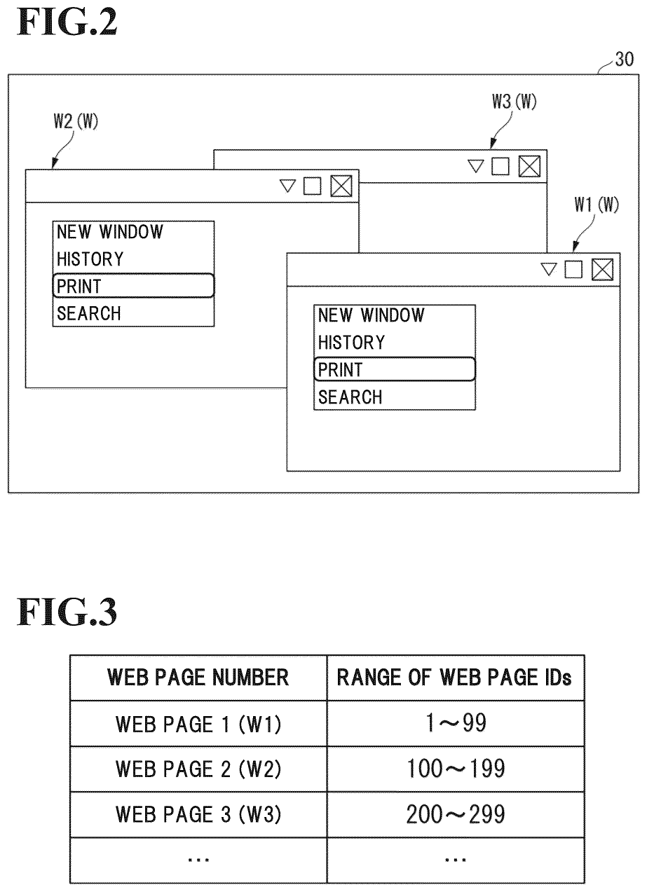

FIG. 2 is an example of the web page W displayed on the display device 30 in the at least one embodiment. The web browser 110 can simultaneously display a plurality of web pages W on the display device 30. In FIG. 2, a case in which a first web page W1, a second web page W2, and a third web page W3 are being simultaneously displayed is illustrated as an example.

Referring back to FIG. 1, the relay software 120 includes, as software functional module thereof, an identification information acquisition module 121, a print request acquisition module 122, a control instruction transmission module 123, a response reception module 124, a determination module 125, and a response notification module 126.

The identification information acquisition module 121 acquires page identification information 1211 that identifies the web page W of the print request source among the plurality of web pages W.

### [Example of Acquiring Page Identification Information (1)]

When the identification information acquisition module 121 detects that the web page W has been closed, the identification information acquisition module 121 acquires the page identification information 1211. In this case, the page identification information 1211 is information indicating that the web page W has been closed, that is, the web page W to which a response is supposed to be returned to a request sent from the web page W has already been closed.

More specifically, a program that notifies the identification information acquisition module 121 that the web page W of the print request source has been closed is run in advance on the web page W. When the web page W is closed, the program running on the web page W notifies the identification information acquisition module 121 that the web page W has been closed. The identification information acquisition module 121 detects, based on this notification, that the web page W of the print request source has been closed. When the web page W of the print request source is closed, information indicating that the web page W has been closed (for example, a value such as zero (0), NULL, or FALSE) is substituted into the page identification information 1211 on the web page W. The identification information acquisition module 121 acquires the page identification information 1211 into which such information indicating that the web page W has been closed has been substituted.

### [Example of Acquiring Page Identification Information (2)]

The relay software 120 may have a function of establishing a connection to the web browser 110 via so-called WebSocket. In this case, the relay software 120 opens a WebSocket set to be connectable only to one web page W at the same timing. When a WebSocket connection request is sent from the web page control module 111, the identification information acquisition module 121 detects the WebSocket connection request. When the identification information acquisition module 121 detects the WebSocket connection request, the identification information acquisition module 121 generates a web page ID. The WebSocket connection request refers to information indicating a status of connection to the web page W.

In a case of this example, the identification information acquisition module 121 generates identification information unique to each web page W, to thereby acquire page identification information. As a specific example, each time the identification information acquisition module 121 detects the WebSocket connection request, the identification information acquisition module 121 increments (counts up) the web page ID, to thereby generate a unique web page ID for each newly opened web page W. As another example, the identification information acquisition module 121 may identify a web page W by assigning any one of values indicated by a binary flag (for example, zero (0) or 1) to the web page W as the web page ID each time the WebSocket connection request is detected.

That is, the identification information acquisition module 121 generates the page identification information 1211 based on the information indicating the status of connection to the web page W, to thereby acquire the page identification information 1211.

### [Example of Acquiring Page Identification Information (3)]

There is a case in which the web page W is assigned unique identification information (for example, the web page ID) in advance. In this case, the identification information acquisition module 121 acquires the web page ID from the web page W, to thereby acquire the page identification information 1211. The above-mentioned plurality of web pages W (for example, the first web page W1, the second web page W2, and the third web page W3) are each identified by the web page ID. In this example, the web page ID serves as the page identification information 1211.

FIG. 3 is a table for showing an example of a correspondence relationship between the web page W and the page identification information 1211 in the at least one embodiment. In this example, when the web page ID falls between 1 and 99, the web page ID indicates the first web page W1. When the web page ID falls between 100 and 199, the web page ID indicates the second web page W2, and when the web page ID falls between 200 and 299, the web page ID indicates the third web page W3.

Referring back to FIG. 1, the identification information acquisition module 121 acquires the page identification information 1211 on the web page W being displayed by the web page control module 111. In this example, as illustrated in FIG. 2, the web page control module 111 is displaying the first web page W1, the second web page W2, and the third web page W3. In this case, the identification information acquisition module 121 acquires the web page ID of any one of 1 to 99 as the page identification information 1211 on the first web page W1. The identification information acquisition module 121 also acquires the web page ID of any one of 100 to 199 as the page identification information 1211 on the second web page W2, and acquires the web page ID of any one of 200 to 299 as the page identification information 1211 on the third web page W3. That is, the identification information acquisition module 121 acquires the page identification information 1211 uniquely assigned to each web page W from the web page control module 111.

The print request acquisition module 122 acquires a print request 1231 that is a request regarding the printing apparatus 50 from the web page W identified by the page identification information 1211. The control instruction transmission module 123 transmits a print instruction CMD based on the print request 1231 to the printing apparatus 50. The response reception module 124 receives, from the printing apparatus 50 that transmits a response RS corresponding to the print instruction CMD, the response RS. The determination module 125 determines whether the web page W that has output the print request 1231 is ready to be notified or not ready to be notified. When the determination module 125 determines that the web page W that has output the print request 1231 is ready to be notified, the response notification module 126 notifies the web page W that has output the print request 1231 of information regarding the response RS. When the determination module 125 determines that the web page W that has output the print request 1231 is not ready to be notified, the response notification module 126 does not notify the web page W that has output the print request 1231 of the information regarding the response RS.

Now, operations of those respective modules are described in more detail. The following description is based on the above-mentioned method using WebSocket, but the present invention is not limited thereto.

### [Flow of Operations of Printing System 1]

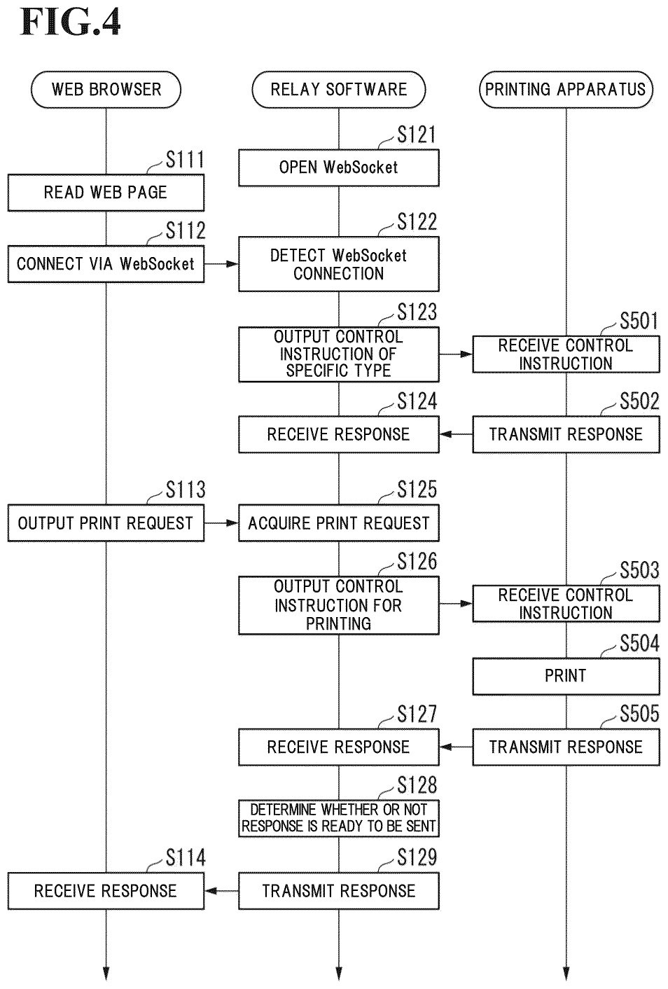

FIG. 4 is a flow chart for illustrating an example of a flow of operations of the printing system 1 in the at least one embodiment.

[Operation Performed when New Web Page is Opened]

(Step S121) The relay software 120 opens WebSocket set to be connectable only to one web page W at the same timing.

(Step S111) The web page control module 111 of the web browser 110 acquires the HTML data 201 from the web server 20. The web page control module 111 displays, on the display device 30, the web page W configured by interpreting the acquired HTML data 201. That is, the web page control module 111 reads the web page W.

(Step S112) The web page control module 111 requests the relay software 120 for a WebSocket connection in accordance with an instruction of the program written in a script language.

(Step S122) The identification information acquisition module 121 of the relay software 120 detects a WebSocket connection request sent from the web page control module 111. When the identification information acquisition module 121 detects the WebSocket connection request, the identification information acquisition module 121 determines that a new web page W has been opened.

The identification information acquisition module 121 acquires the page identification information 1211 on the newly opened web page W by any one of the above-mentioned methods.

(Step S123) The control instruction transmission module 123 of the relay software 120 outputs a control instruction CMD to the printing apparatus 50.

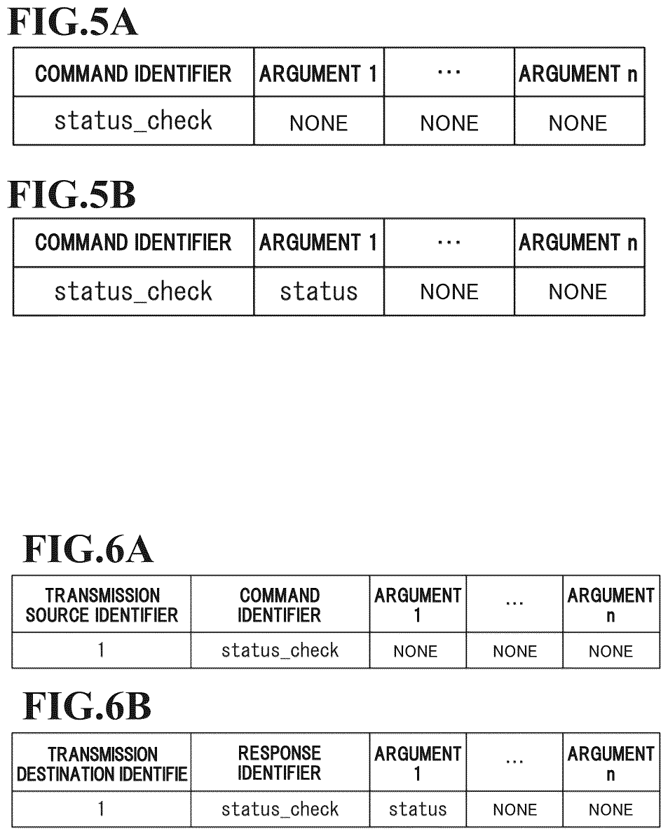

FIG. 5A and FIG. 5B are tables for showing an example of structures of the control instruction CMD and the response RS in the at least one embodiment. The control instruction CMD as used herein refers to information for causing the printing apparatus 50 to execute an operation determined in advance, and information to be transmitted by the terminal device 10 to the printing apparatus 50. The response RS refers to information to be returned by the printing apparatus 50 that has received the control instruction CMD from the terminal device 10 to the terminal device 10 that has transmitted the control instruction CMD. FIG. 5A shows an example of a structure of the control instruction CMD, and FIG. 5B shows an example of the response RS. As types of the control instruction CMD, there are a type that requires the response RS from the printing apparatus 50 to the control instruction CMD of the terminal device 10, and a type that requires no response RS. The following description is given of the control instruction CMD of the type that requires the response RS.

The control instruction CMD includes a command identifier, an argument 1, . . . , and an argument “n” (where “n” is a natural number). The response RS includes a response identifier, an argument 1, . . . , and an argument “n” (where “n” is a natural number). The command identifier refers to information indicating a type of operation that the terminal device 10 instructs the printing apparatus 50 to perform. The response identifier refers to information indicating a type of operation that has been performed by the printing apparatus 50 in accordance with an instruction of the terminal device 10. Examples of types of control instructions CMD include printing, sheet feeding, and notification of a status of the printing apparatus 50. The command identifier and the response identifier each indicate which of the printing, the sheet feeding, the notification of the status of the printing apparatus 50, . . . the type of the control instruction CMD is.

The relay software 120 may directly forward the control instruction CMD directed to the printing apparatus 50, which has been output by the print script of the web browser 110, to the printing apparatus 50 as the control instruction CMD. The relay software 120 may also interpret an operation instruction (for example, the print instruction) directed to the printing apparatus 50, which has been output by the print script of the web browser 110, convert the interpreted operation instruction into a print instruction command in a format defined by the printing apparatus 50, and transmit the print instruction command to the printing apparatus 50 as the control instruction CMD.

There is a case in which the relay software 120 transmits a plurality of types of control instructions CMD in sequence. The relay software 120 can examine, based on the response identifier included in the received response RS, which of the plurality of types of control instructions CMD transmitted in sequence the response RS corresponds to.

As the types of control instructions CMD, there are types that involve an operation of a printing mechanism of the printing apparatus 50 and types that do not involve the operation of the printing mechanism of the printing apparatus 50. The printing mechanism of the printing apparatus 50 refers to a printer head, a sheet feeding device, or the like. The types that do not involve the operation of the printing mechanism of the printing apparatus 50 include a status check (status_check) of the printing apparatus 50 and a version check (ver_check) of firmware of the printing apparatus 50. The type of control instruction CMD that does not involve the operation of the printing mechanism of the printing apparatus 50, such as the status check (status_check), is also referred to as “first control instruction CMD1” (or “specific control instruction”; the same applies in the following description). Meanwhile, the type of control instruction CMD that involves the operation of the printing mechanism of the printing apparatus 50, such as the printing or the sheet feeding, is also referred to as “second control instruction CMD2.”

In Step S123, the control instruction transmission module 123 transmits the type of control instruction CMD that does not involve the operation of the printing mechanism of the printing apparatus 50 (namely, the first control instruction CMD1) to the printing apparatus 50. For example, the control instruction transmission module 123 transmits the control instruction CMD for the status check (status_check) to the printing apparatus 50. When the printing apparatus 50 receives the control instruction CMD for the status check (status_check), the printing apparatus 50 returns the response RS corresponding to the received control instruction CMD to the relay software 120.

That is, the control instruction transmission module 123 transmits the specific control instruction corresponding to the page identification information 1211 to the printing apparatus 50.

The first control instruction CMD1 (specific control instruction) as used herein refers to, among the control instructions CMD of the printing apparatus 50, a control instruction CMD requiring the response RS to the control instruction CMD from the printing apparatus 50 and involving no operation of the printing mechanism of the printing apparatus 50.

According to the relay software 120 configured in the above-mentioned manner, it is possible to examine which control instruction CMD the response RS corresponds to, without operating the printing mechanism of the printing apparatus 50, by transmitting the first control instruction CMD1 to the printing apparatus 50.

The above-mentioned structures of the control instruction CMD and the response RS are merely examples, and the present invention is not limited thereto. For example, the control instruction CMD and the response RS may have such structures as shown in FIG. 6A and FIG. 6B.

FIG. 6A and FIG. 6B are tables for showing a modification example of the structures of the control instruction CMD and the response RS in the at least one embodiment. In this modification example, in addition to respective pieces of information shown in FIG. 5A and FIG. 5B, the control instruction CMD includes a transmission source identifier, and the response RS includes a transmission destination identifier.

The page identification information 1211 (for example, “1”) acquired by the identification information acquisition module 121 in Step S122 is substituted into the transmission source identifier. The transmission source identifier (namely, the page identification information 1211, for example, “1”) included in the control instruction CMD received by the printing apparatus 50 is substituted into the transmission destination identifier of the response RS. In a case of having transmitted a plurality of control instructions CMD, the terminal device 10 can determine, by comparing the transmission source identifier of the control instruction CMD and the transmission destination identifier of the response RS to each other, which control instruction CMD the response RS corresponds to.

(Step S501) Referring back to FIG. 4, the printing apparatus 50 receives the first control instruction CMD1 from the relay software 120.

(Step S502) The printing apparatus 50 transmits, to the relay software 120, the response RS to the control instruction CMD received in Step S501.

(Step S124) The response reception module 124 receives the response RS transmitted from the printing apparatus 50 in Step S502.

In this case, the response RS transmitted in Step S502 can be said to be the response RS that includes an identification result of the web page W included in the specific control instruction transmitted in Step S123. That is, the response reception module 124 receives the response RS that includes the identification result corresponding to the specific control instruction from the printing apparatus 50.

The determination module 125 determines whether or not the received response RS is the response RS corresponding to the first control instruction CMD1 transmitted in Step S123. Specifically, the determination module 125 determines whether or not the received response RS is the response RS corresponding to the first control instruction CMD1 based on whether or not the command identifier of the first control instruction CMD1 and the response identifier of the response RS, which are shown in FIG. 5A and FIG. 5B, match each other. In another case, the determination module 125 determines whether or not the received response RS is the response RS corresponding to the first control instruction CMD1 based on whether or not the transmission source identifier of the first control instruction CMD1 and the transmission destination identifier of the response RS, which are shown in FIG. 6A and FIG. 6B, match each other.

As described above, the series of operations from Step S122 to Step S124 is performed as follows. That is, when the identification information acquisition module 121 detects a WebSocket connection request, the identification information acquisition module 121 determines that a new web page W has been opened.

The identification information acquisition module 121 acquires the page identification information 1211 for the newly opened web page W by any one of the above-mentioned methods. The control instruction transmission module 123 transmits the first control instruction CMD1 to the printing apparatus 50. The printing apparatus 50 transmits, to the relay software 120, the response RS to the first control instruction CMD1. That is, the relay software 120 transmits the first control instruction CMD1 on the condition that the newly opened web page W has been identified, and receives the response RS to the first control instruction CMD1 from the printing apparatus 50. The determination module 125 determines whether or not the received response RS is the response RS to the first control instruction CMD1 transmitted on condition that the newly opened web page W has been identified.

That is, the response RS can be said to include information indicating the identification result of the web page W based on the page identification information 1211.

[Operation Performed when Print Request is Made]

(Step S113) The web page control module 111 of the web browser 110 outputs the print request 1231 to the terminal device 10. The print request 1231 is generated when, for example, the user operating the web browser 110 performs an operation of instructing the print script of a web page being displayed on the display device 30 to perform printing. In this case, when the web page control module 111 detects a print instruction operation performed by the user, the web page control module 111 outputs the print request 1231 to the terminal device 10.

(Step S125) The print request acquisition module 122 acquires the print request 1231 output by the web page control module 111. The web page W being displayed on the display device 30 by the web page control module 111 as used herein refers to the web page W identified by the page identification information 1211 as described above.

That is, the print request acquisition module 122 acquires the print request 1231 that is a request regarding the printing apparatus 50 from the web page W identified by the page identification information 1211.

(Step S126) The control instruction transmission module 123 transmits the control instruction CMD (namely, the print instruction) based on the print request 1231 to the printing apparatus 50.

(Step S503) The printing apparatus 50 receives the control instruction CMD serving as the print instruction.

(Step S504) The printing apparatus 50 executes the printing based on the print request sent from the web page W designated by the control instruction CMD.

The printing operation performed by the printing apparatus 50 and exchange of the control instruction CMD for the printing operation are well known, and hence description thereof is omitted.

(Step S505) The printing apparatus 50 transmits the response RS indicating that printing has been completed to the relay software 120.

(Step S127) The response reception module 124 receives the response RS from the printing apparatus 50 that transmits the response RS corresponding to the print instruction CMD.

(Step S128) The determination module 125 determines whether or not a response to the web page W that has output the print request 1231 is ready to be sent.

As described above, the determination module 125 determines in Step S124 whether or not the received response RS is the response RS corresponding to the first control instruction CMD1. For example, the determination module 125 determines whether or not the received response RS is the response RS corresponding to the first control instruction CMD1 based on whether or not the command identifier of the first control instruction CMD1 and the response identifier of the response RS match each other. When the command identifier of the first control instruction CMD1 and the response identifier of the response RS match each other, the determination module 125 determines that the web page W that has output the print request 1231 is ready to be notified. Meanwhile, when the command identifier of the first control instruction CMD1 and the response identifier of the response RS do not match each other, the determination module 125 determines that the web page W that has output the print request 1231 is not ready to be notified.

That is, the determination module 125 determines whether the web page W that has output the print request 1231 is ready to be notified or not ready to be notified.

Cases in which the web page that has output the print request is not ready to be notified include not only a case in which the web page W has been closed but also, for example, a case in which the web browser 110 has been closed or a case in which the WebSocket connection between the web page W and the relay software 120 has been disconnected.

(Step S129) Referring back to FIG. 4, when the determination module 125 determines that the web page W that has output the print request 1231 is ready to be notified, the response notification module 126 notifies the web page W that has output the print request 1231 of the information regarding the response RS. Meanwhile, when the determination module 125 determines that the web page W that has output the print request 1231 is not ready to be notified, the response notification module 126 does not notify the web page W that has output the print request 1231 of the information regarding the response RS.

That is, the response notification module 126 notifies, based on the identification result of the web page W, the web page W identified by the page identification information 1211 of the information regarding the received response RS with the print request 1231 and the response RS being associated with each other.

The above-mentioned “information regarding the response RS” may be the response RS itself, or may be information obtained by subjecting the response RS to some conversion (for example, format conversion or aggregation of a plurality of responses RS) in the relay software 120.

(Step S114) When the web page W that has output the print request 1231 is notified of the response RS in Step S129, the web page control module 111 receives the response RS.

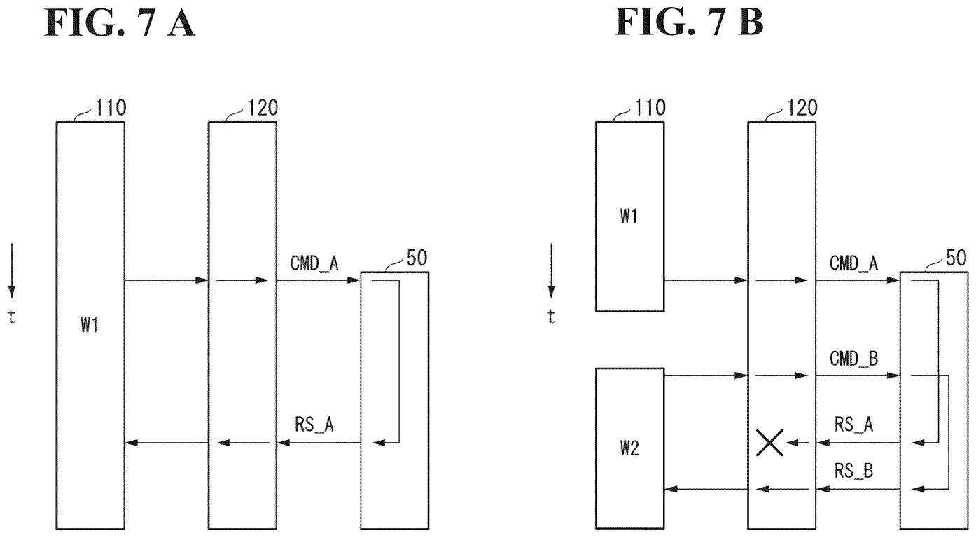

FIG. 7A and FIG. 7B are diagrams for illustrating an example of a determination operation performed by the determination module 125 in the at least one embodiment. FIG. 7A is an illustration of a situation in which the first web page W1 of the web browser 110 and the relay software 120 output a control instruction CMD_A and the printing apparatus 50 returns a response RS_A to the first web page W1. FIG. 7B is an illustration of a situation in which the first web page W1 of the web browser 110 and the relay software 120 output the control instruction CMD_A, then the first web page W1 is closed, and the second web page W2, which is a new web page W, is opened.

In the case of FIG. 7B, the response RS_A of the printing apparatus 50 to the control instruction CMD_A is returned to the relay software 120 after the second web page W2 is opened. In this case, when the relay software 120 notifies the second web page W2 of the response RS_A, the second web page W2 adversely receives an unexpected response RS (response RS_A). In this case, depending on a design of the second web page W2, reception of the unexpected response RS_A may cause an unintended behavior.

As illustrated in FIG. 7B, when the second web page W2 is opened, the relay software 120 in the at least one embodiment transmits a control instruction CMD_B (specific control instruction described above) to the printing apparatus 50. The printing apparatus 50 returns a response RS_B to the control instruction CMD_B to the relay software 120. As illustrated in FIG. 7B, after having transmitted the control instruction CMD_B, the relay software 120 receives the response RS_A and the response RS_B in the stated order. In this case, the page identification information 1211 of the control instruction CMD_B and the page identification information 1211 of the response RS_A do not match each other. The page identification information 1211 of the control instruction CMD_B and the page identification information 1211 of the response RS_B match each other.

When the response RS_A is received after the control instruction CMD_B has been transmitted, the determination module 125 in the at least one embodiment determines that the response RS that does not correspond to the control instruction CMD_B (namely, the control instruction CMD of the second web page W2) has been received. In this case, even when the determination module 125 receives the response RS_A, the response notification module 126 does not notify the second web page W2 of the response RS_A.

That is, the printing system 1 in the at least one embodiment inhibits the newly opened web page W (for example, the second web page W2) from being notified of the unexpected response RS (for example, the response RS_A) with respect to the already closed web page W (for example, the first web page W1). That is, the printing system 1 in the at least one embodiment inhibits notification of the response RS that does not correspond to the second web page W2.

According to the printing system 1 configured in the above-mentioned manner, even when an operation in which the user closes the web page W or the like occurs, it is possible to avoid notifying the second web page W2 of the unexpected response RS, thereby being able to inhibit an unintended behavior.

All or a part of the functions of the terminal device 10 described above may be recorded as a program on a computer-readable recording medium, and this program may be executed by a computer system. The computer system includes an OS and a peripheral device and other such hardware. Examples of the computer-readable recording medium include a flexible disk, a magneto-optical disk, a read only memory (ROM), a CD-ROM, and other such portable medium, a hard disk drive built into the computer system and other such storage device, and a volatile memory (random access memory (RAM)) provided by a server on the Internet or other such network. The volatile memory is an example of a recording medium which holds a program for a fixed period of time.

In addition, the above-mentioned program may be transmitted to another computer system through a transmission medium, for example, the Internet or other such network or a telephone line or other such communication line.

The above-mentioned program may also be a program for implementing all or a part of the above-mentioned functions. The program for implementing a part of the above-mentioned functions may be a so-called differential program capable of implementing the above-mentioned functions in combination with a program recorded in advance in the computer system.

While the at least one embodiment of the present invention has been described above with reference to the drawings, specific configurations are not limited to those in the above-mentioned at least one embodiment, and design changes and the like within a scope that does not depart from the gist of the present invention are also included in the present invention.

What is claimed is:

1. A printing control device, comprising:
an identification information acquisition module configured to acquire page identification information that identifies a web page of a request source among a plurality of web pages;
a print request acquisition module configured to acquire a print request that is a request regarding a printing apparatus from the web page identified by the page identification information;
a control instruction transmission module configured to transmit a control instruction based on the print request to the printing apparatus;
a response reception module configured to receive, from the printing apparatus that transmits a response corresponding to the control instruction, the response;
a determination module configured to determine whether the web page that has output the print request is ready to be notified; and
a response notification module configured to notify the web page that has output the print request of information regarding the response when the determination module determines that the web page that has output the print request is ready to be notified, and otherwise avoid notifying the web page that has output the print request of the information regarding the response.

2. The printing control device according to claim 1, wherein the identification information acquisition module is configured to generate the page identification information based on information indicating a status of connection to the web page, to thereby acquire the page identification information.

3. The printing control device according to claim 1,
wherein the response includes information indicating an identification result of the web page based on the page identification information, and
wherein the response notification module is configured to notify, based on the identification result, the web page identified by the page identification information of the information regarding the received response with the print request and the response being associated with each other.

4. The printing control device according to claim 3,
wherein the control instruction transmission module is configured to transmit, to the printing apparatus, a specific control instruction corresponding to the page identification information, and
wherein the response reception module is configured to receive the identification result corresponding to the specific control instruction from the printing apparatus.

5. The printing control device according to claim 4, wherein the specific control instruction comprises, among control instructions of the printing apparatus, a control instruction requiring a response to the control instruction from the printing apparatus and involving no operation of a printing mechanism of the printing apparatus.

6. A printing control method, which is performed by a computer device, comprising:
acquiring page identification information that identifies a web page of a request source among a plurality of web pages;
acquiring a print request that is a request regarding a printing apparatus from the web page identified by the page identification information;
transmitting a control instruction based on the print request to the printing apparatus;
receiving, from the printing apparatus that transmits a response corresponding to the control instruction, the response;
determining whether the web page that has output the print request is ready to be notified; and
notifying the web page that has output the print request of information regarding the response when it is determined that the web page that has output the print request is ready to be notified, and otherwise avoiding notifying the web page that has output the print request of the information regarding the response.

7. A program for causing a computer device to:
acquire page identification information that identifies a web page of a request source among a plurality of web pages;
acquire a print request that is a request regarding a printing apparatus from the web page identified by the page identification information;
transmit a control instruction based on the print request to the printing apparatus;
receive, from the printing apparatus that transmits a response corresponding to the control instruction, the response;
determine whether the web page that has output the print request is ready to be notified; and
notify the web page that has output the print request of information regarding the response when it is determined that the web page that has output the print request is ready to be notified, and otherwise avoid notifying the web page that has output the print request of the information regarding the response.
